(19) United States
(12) Patent Application Publication
(10) Pub. No.: US 2009/0316524 A1
(43) Pub. Date: Dec. 24, 2009

(54) Flexible seismic data acquisition system for use in a marine environment

(76) Inventor: Stig Rune Tenghamn, Katy, TX (US)

Correspondence Address: E. Eugene Thigpen;Petroleum Geo-Services, Inc., P.O. Box 42805, Houston, TX, 77242-2805, US

(21) Appl. No.: 12/214,846

(22) Filed: Jun. 23, 2008

(51) Int. Cl. G01V 1/38

(52) U.S. Cl. 367/16

(57) ABSTRACT

Systems and methods for marine seismic surveying of strata beneath a seafloor are disclosed, including, in certain aspects, locating an under water sensor cable with sensing apparatus on a seafloor beneath water; the cable having a first end connected to a first unmanned powered vehicle and a second end connected to a second unmanned powered vehicle; and, with the two vehicles, locating, moving, re-locating, raising, and/or maintaining tension on the cable. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### BACKGROUND OF THE INVENTION

1. Field of the Invention

The present invention is directed to systems and method for acquiring seismic data; to such systems and methods which employ seabed cables with sensors; and, in certain particular aspects, to systems and methods for facilitating the movement of seabed cables and for effectively maintaining such cables in position during operations, particularly during shallow (two hundred feet deep or less) operations.

2. Description of Related Art

The structure and character of subsurface geological formations underlying a body of water are investigated, surveyed, and mapped using a variety of marine seismic exploration techniques and systems. In certain known systems, for what is known as “seabed” seismic data acquisition, a cable containing seismic sensors or receivers is laid on the seabed from a surface vessel, typically from a reel system on the vessel.

A variety of problems are associated with laying and positioning seabed sensor cables. Both during initial laying of the cable and during subsequent operations, it is important that the cable and its sensors are positioned at a desired location and remain there. Water currents, vessel movement, and cable movement, rolling, and twisting can result in damage to a cable and undesirable movement of and repositioning of the sensors.

For effective operation of the sensors of a seabed cable for sensing reflected shear waves, the sensors must be effectively coupled to the seafloor. If the sensors move and decouple, effective operation and substrata investigation is hindered or is not possible.

FIGS. 1A-1C show a known marine seismic survey system S which includes a vessel V towing a seismic source R and a vessel L for deploying a seabed sensor cable C with sensor units U on the seabed. Optionally, only one vessel is used. The seismic source R emits acoustic pulses or pressure waves P which are reflected from different underground formation layers Y. The reflected acoustical energy, indicated by lines N, is partly shear waves and partly compression waves. This reflected energy is detected by the sensor units U which transmit signals to a recording system G on the vessel L.

FIG. 1D shows a typical known reel mechanism for deployment and retrieval of a seabed cable. A seabed cable D with sensors M passes over a sheave E and onto a reel P of a winch system W. The system W is on a vessel like the vessel L.

As shown in FIG. 1B, the cable C is in a desired location on the seafloor and with respect to the vessel L. As shown in FIG. 1C, the cable C can move or twist with respect to the vessel L and can move or roll with respect to the seafloor so that the sensor units U either decouple from the seafloor or move to an undesirable location.

A variety of prior attempts have been made to insure the correct positioning of seabed sensor cables and to maintain desired positioning once achieved. U.S. Pat. No. 4,942,557 discloses a marine seismic cable of sufficient weight that its sensors do not decouple from the seafloor. U.S. Pat. No. 3,921,755 discloses a towable seismic detector conveyance which has sufficient mass that it hugs the seafloor without the need for additional weights, which resists twisting, and which maintains seismic sensors in contact with the seafloor. It is moved by a single tow vehicle.

U.S. Pat. No. 5,747,754 discloses a seabed sensor cable with a vibrator apparatus to vibrate geophone units to embed them in the seafloor, thereby anchoring the system in place.

U.S. Pat. No. 4,725,990 discloses a marine seismic cable with one or more weight assemblies for maintaining cable sensors in contact with the seafloor.

U.S. Pat. No. 5,274,603 discloses a marine seismic cable with internal stress members for resisting twisting of the cable. The cable is designed, in one aspect, to have a density along its length greater than water so that sensor-seabed coupling is maintained. In certain aspects, the cable is robust so that it can withstand movement on the seafloor, e.g. as it is dragged into place. In certain aspects, the cable is designed to resist rolling on the seafloor.

U.S. Pat. No. 5,142,499 discloses a seabed cable armored to withstand injury due to twisting, ocean currents, and dragging on the seafloor.

The present inventor has recognized the need for efficient and effective systems and methods for initially positioning seabed sensor cables; for minimizing damage to such cables when they are in position; and for maintaining them in position for effective operation.

### BRIEF SUMMARY OF THE INVENTION

The present invention discloses, in certain aspects, methods for marine seismic surveying of strata beneath a seafloor beneath water, the methods including: locating a sensor cable with sensing apparatus beneath water, the sensor cable having a first end connected to a first unmanned powered vehicle at a surface of the water and a second end connected to a second unmanned powered vehicle at the surface of the water; and with the two unmanned powered vehicles, maintaining a location of the sensor cable.

Accordingly, the present invention includes features and advantages which are believed to enable it to advance marine seismic technology. Characteristics and advantages of the present invention described above and additional features and benefits will be readily apparent to those skilled in the art upon consideration of the following detailed description of certain embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention within the scope of the claims herein. The claims of this invention are to be read to include any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain embodiments, given for the purpose of disclosure, when taken in conjunction with the accompanying drawings. The detail in these descriptions is not intended to thwart this patent's object to claim this invention no matter how others may later attempt to disguise it by variations in form or additions of further improvements. Certain aspects, certain embodiments, and certain preferable features of the invention are set out herein. Any combination of aspects or features shown in any aspect or embodiment can be used except where such aspects or features are mutually exclusive.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated features, aspects, improvements and/or technical advantages and/or elements in claims to this invention.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate certain embodiments and are not to be used to improperly limit the scope of the invention which may have other equally effective or equivalent embodiments.

FIG. 1A is a side schematic view of a prior art marine seismic system.

FIG. 1B is a top view of part of the system of FIG. 1A.

FIG. 1C is an alternate top view of part of the system of FIG. 1A.

FIG. 1D is a side schematic view of a prior art cable reel system.

FIG. 2A is a side schematic view of a seabed sensor cable system according to the present invention.

FIG. 2B is a side schematic view showing a cable of the system of FIG. 2A raised from the seafloor.

FIG. 3A is a side schematic view of the system of FIG. 2A with a vessel moving transverse to the seabed cable of FIG. 2A.

FIG. 3B is a side schematic view of the system of FIG. 2A with a vessel moving parallel to the seabed cable of FIG. 2A.

FIG. 4A is a top schematic view of seabed sensor cable systems according to the present invention.

FIG. 4B is a top schematic view of seabed sensor cable systems according to the present invention.

FIG. 4C is a top schematic view of seabed sensor cable systems according to the present invention.

FIG. 5 is a side schematic view of a system according to the present invention.

FIG. 6 is a top schematic view of a system according to the present invention.

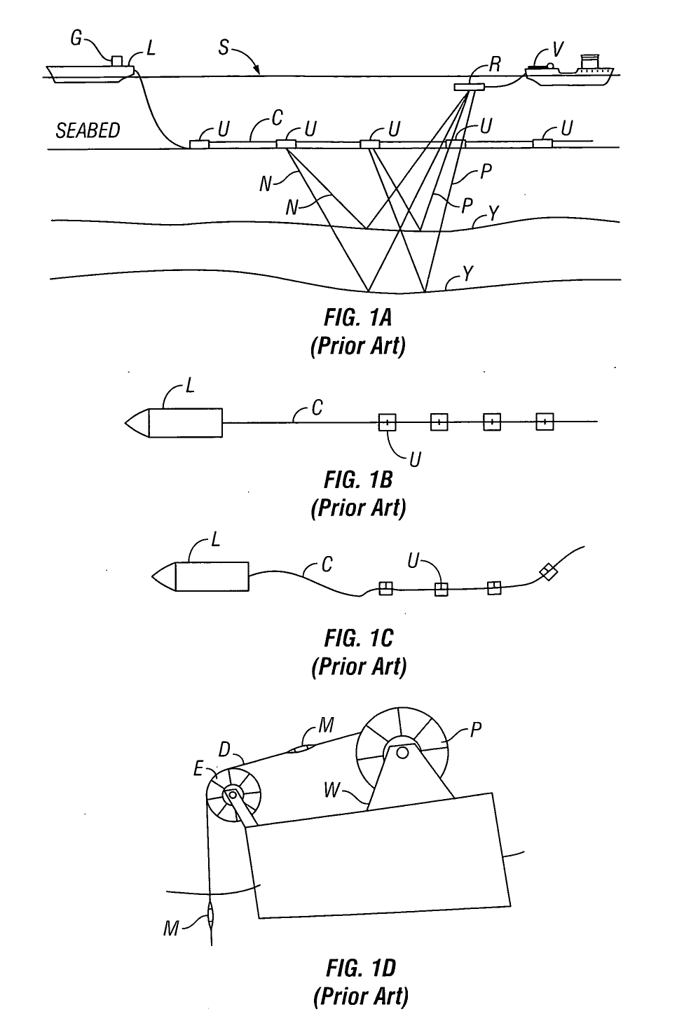

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of certain particular embodiments and are not intended to limit the invention or the appended claims. On the contrary, the intention is to cover all modifications, equivalents and alternatives falling within the spirit and scope of the invention as defined by the appended claims. In showing and describing the detailed embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

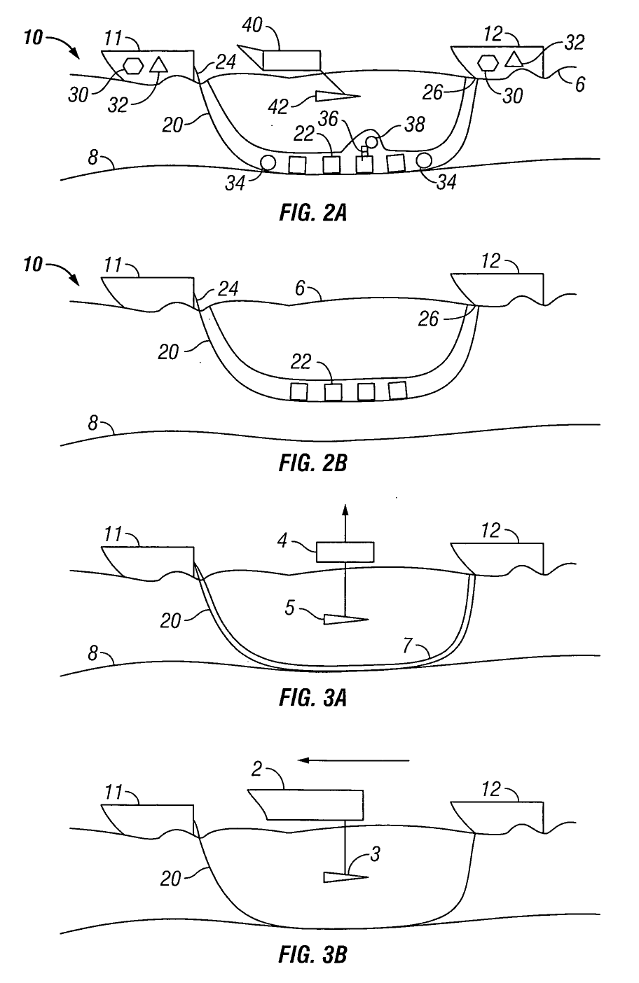

Referring now to FIG. 2A, a seabed sensor cable system 10 according to the present invention includes a seabed sensor cable 20 with multiple spaced-apart seismic sensor units 22. A first end 24 of the cable 20 is connected to a first unmanned vehicle 11 at a water surface 6 and a second end 26 of the cable 20 is connected to a second unmanned vehicle 12. The vehicles 11, 12 are located so that the sensor units 22 are in coupling contact with a seafloor 8. In one aspect, the vehicles 11, 12 maintain constant tension on the cable 20. In one aspect the vehicles 11 and 12 are known unmanned surface vehicles.

As shown in FIG. 2B, by moving either the vessel 11, the vessel 12, or both vessels 11, 12, the cable 20 is raised from the seafloor 8 for relocation of the cable 20 and of the sensor units 22. This minimizes dragging of the cable 20 on the seafloor during relocation.

Raising the cable 20 for relocation (see FIG. 2B) or retrieval using the two vehicles 11, 12 inhibits twisting of the cable 20 and provides control of the cable's location during movement.

Each vehicle 11, 12 has a signal recording/processing system 30 for receiving and processing signals from the sensor units 22 transmitted through the cable 20. Each vehicle 11, 12 has an on-board control/navigation system 32. The vehicles 11, 12 can be remotely controlled. As shown in FIG. 2A, the vehicles 11, 12 are relatively stationary when recording data from the sensor units 22.

Optionally, it is within the scope of the present invention to use any known apparatus or device 34 (one, two or more) to enhance coupling of the sensor units 22 with the seafloor (e.g., but not limited to, weights, anchors, vibrators, etc.).

A source vessel 40 has a seismic source 42. The source vessel 40 may be moving or stationary.

FIG. 3A illustrates a vessel 4 towing a seismic source 5. The vessel 4 moves transverse to the cable 20 (or transverse to multiple seabed sensor cable systems according to the present invention). FIG. 3B illustrates a vessel 2 towing a seismic source 3. The vessel 2 moves parallel to the cable 20 (or parallel to multiple seabed sensor cable system according to the present invention). It is to be understood that it is within the scope of the present invention for there to be multiple cables 20 spaced-apart on the seafloor above which a vessel with a seismic source moves.

Optionally, any cable according to the present invention may have a selectively fillable air hose 7 (see FIG. 3A) for facilitating the raising of the cable 20 as desired.

Optionally, some or all of the sensor units 22 have a sensor pad 36 (see FIG. 2A) with a device 38 which is inflatable or which can selectively change density to assist in raising the cable 20. In one aspect of a method according to the present invention, the devices 38 are made buoyantly neutral, the cable rises, and the two vessels 11, 12 move the cable 20 to a new location.

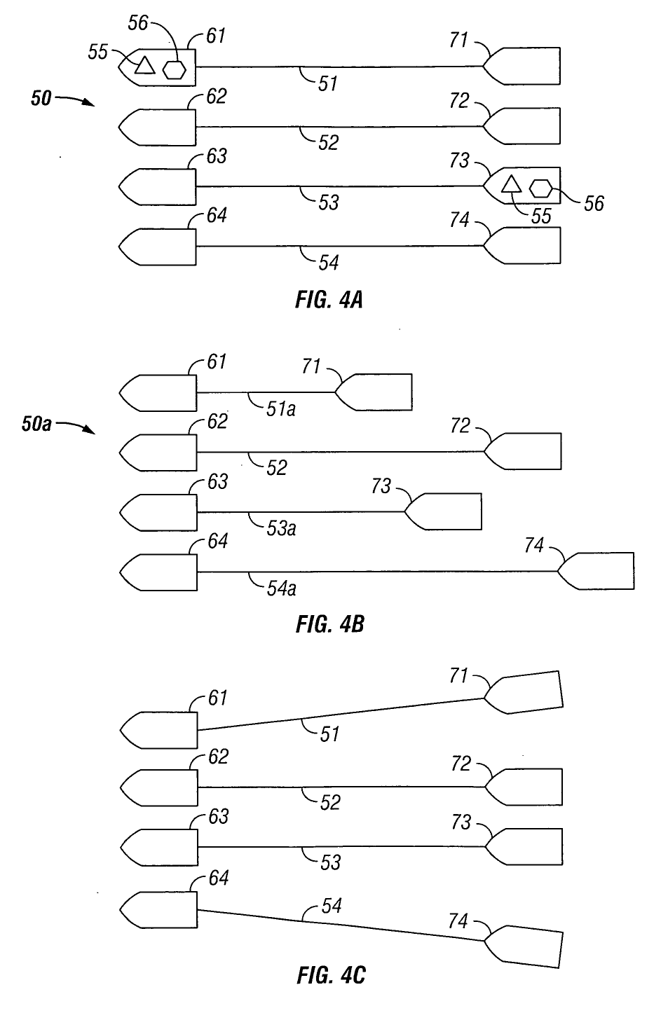

FIG. 4A shows a system 50 according to the present invention with a plurality of seabed sensor cables 51, 52, 53, 54. Each of the cables 51-54 has a first end connected to a first powered vehicle 61-64, respectively, and a second end connected to a second powered vehicle 71-74, respectively. Any, some or all of the vehicles 51-54 may have a control/navigation system 55 and/or a signal receiving/processing system 56. As shown, the vehicles 61-64 and 71-74 may be controlled so that the cables 51-54 are substantially parallel, substantially equal in length, and substantially equidistantly spaced-apart. Optionally, any one, some, or all the cables may be nonparallel, of different length, and/or spaced-apart nonequidistantly.

FIG. 4B illustrates a system 50a, like the system 50 (and like numerals indicate like parts); but with a cable 51a that is shorter than the cable 51; a cable 53a that is shorter than the cable 53; and a cable 54a that is longer than the cable 54. The cables in FIG. 4B are of different lengths.

FIG. 4C illustrates the system 50 with only the cables 52, 53 parallel to each other; with the cable 51 nonparallel to the other cables; and with the cable 54 nonparallel to the other cables.

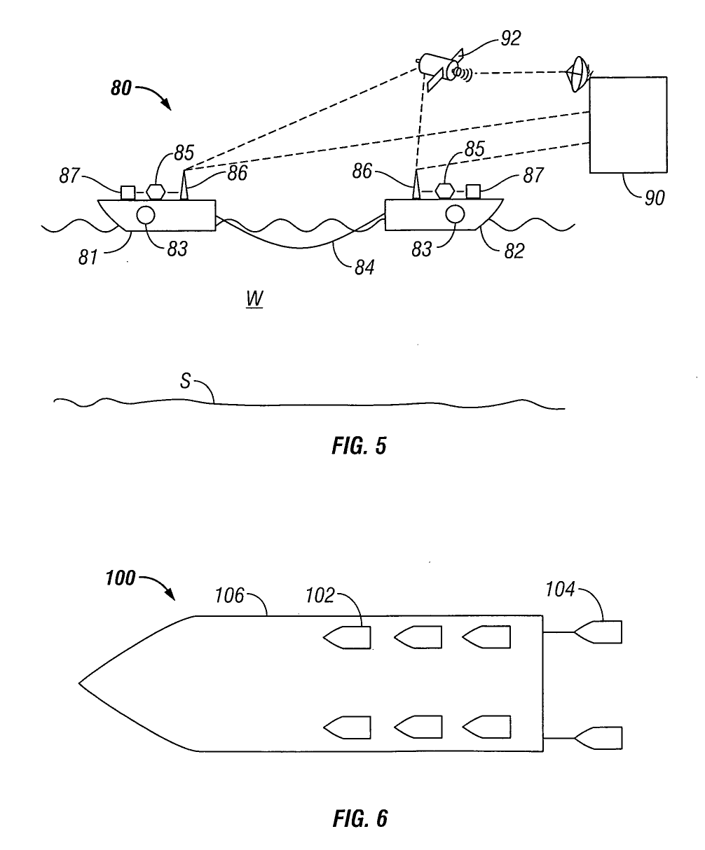

As shown in FIG. 5, unmanned surface vehicles in systems and methods according to the present invention may have on-board generators, radio systems, data recording and/or processing systems, and controls for remote operation from a control function (e.g. on a mother vessel or at a land site). In a system 80 according to the present invention, the USV's 81 and 82 according to the present invention have a cable 84 (any cable disclosed or referred to herein which may be in any location or position of any cable described above or shown in the drawings) between them in water W above a seafloor S (the cable may be on the seafloor). Each USV 81, 82 has a power generator 83; a data system 85 (e.g. for receiving, recording, buffering, processing and/or transmitting seismic data); a radio communications system 86; and/or a control navigation apparatus 87. Optionally, only one of the USV's has a system 85.

A control function 90 remotely controls the USVs 81 and 82 via the radio communications systems 86 and receives data via these systems from the data systems 85. Optionally, communications between the USV's 81, 82 and the control function 90 may be via a satellite system 92.

It is within the scope of the present invention for the control function to be on a mother vessel, at a land site, or both.

As shown in FIG. 6, in certain methods 100 according to the present invention (including any method described above), unmanned surface vehicles 102 used in the method are stored on a larger vessel 106 and/or unmanned surface vehicles 104 are towed by the larger vessel 106. It is within the scope of the present invention for a larger vessel to tow two USVs with a cable attached to them.

The present invention, therefore, provides in some, but not in necessarily all, embodiments a method for marine seismic surveying of strata beneath a seafloor beneath water, the method including: locating a sensor cable with sensing apparatus beneath water, the sensor cable having a first end connected to a first unmanned powered vehicle at a surface of the water and a second end connected to a second unmanned powered vehicle at the surface of the water; and with the two unmanned powered vehicles, maintaining a location of the sensor cable. Such a method according to the present invention may include one, or some, in any possible combination of the following: remotely controlling the first unmanned powered vehicle and the second unmanned powered vehicle with a control function; the control function located on one of a mother vessel and a land site; raising the sensor cable by inflating inflatable apparatus on the cable; the inflatable apparatus being an air hose along a portion of the cable; the inflatable apparatus being an inflatable structure on a sensor pad, the sensor pad on the cable; raising the sensor cable by moving one or both unmanned powered vehicles; moving the sensor cable to a new location by moving one or both unmanned powered vehicles; at least one of the unmanned powered vehicles including a data system for receiving and processing signals from the sensor cable and a communications system for transmitting data to a remote receiver, the method further including receiving with the data system signals from the sensor cable, processing the received signals with the data system, and transmitting processed data from the data system to the remote receiver; the remote receiver being located on one of a mother vessel and a land site; transmitting the processed data from the at least one unmanned powered vehicle to the remote receiver via a satellite system; moving a seismic source vessel having a seismic source thereon with respect to the cable, activating the seismic source production signals transmitted to the strata beneath the seafloor, receiving reflected signals from the strata with the sensor cable, and receiving signals from the sensor cable with a data system on at least one of the unmanned powered vehicles; the seismic source vessel moving transverse to the sensor cable or the seismic source vessel moving parallel to the sensor cable; re-locating the sensor cable on the seafloor using the two unmanned powered vehicles; using at least one of the unmanned powered vehicles, maintaining the sensing apparatus in coupling contact with the seafloor; and/or the seafloor being two hundred feet or less below the surface of the water.

The present invention, therefore, provides in some, but not in necessarily all, embodiments a method for marine seismic surveying of strata beneath a seafloor beneath water, the method including: locating a sensor cable with sensing apparatus beneath water, the sensor cable having a first end connected to a first unmanned powered vehicle at a surface of the water and a second end connected to a second unmanned powered vehicle at the surface of the water; with the two unmanned powered vehicles, maintaining a location of the sensor cable; remotely controlling the first unmanned powered vehicle and the second unmanned powered vehicle with a control function; wherein the seismic source vessel moves transverse or parallel to the sensor cable; wherein the control function is on one of a mother vessel and a land site; raising the sensor cable by inflating inflatable apparatus on the cable; and/or wherein at least one of the unmanned powered vehicles includes a data system for receiving and processing signals from the sensor cable and a communications system for transmitting data to a remote receiver, the method further including moving a seismic source vessel having a seismic source thereon with respect to the cable, activating the seismic source production signals transmitted to the strata below the seafloor, receiving reflected signals from the seafloor with the sensor cable, receiving signals from the sensor cable with the data system on at least one of the unmanned powered vehicles, processing the received signals with the data system, and wherein the remote receiver is located on one of a mother vessel and a land site.

The present invention, therefore, provides in some, but not in necessarily all, embodiments a method for marine seismic surveying of strata beneath a seafloor beneath water, the method including: locating a plurality of sensor cables each with sensing apparatus beneath water, the sensor cables each having a first end connected to a first unmanned powered vehicle at a surface of the water and a second end connected to a second unmanned powered vehicle at the surface of the water; and with the unmanned powered vehicles, maintaining locations of the sensor cables. Such a method according to the present invention may include one, or some, in any possible combination of the following: each of the sensor cables being of substantially the same length; at least two of the sensor cables being of different lengths; the sensor cables positioned parallel to each other; and/or at least two of the sensor cables not parallel to each other.

The present invention, therefore, provides in some, but not in necessarily all, embodiments a system for marine seismic surveying, the system including: at least one sensor cable with a first end and a second end; a first unmanned powered vehicle, the first unmanned powered vehicle connected to the first end of the sensor cable; and a second unmanned powered vehicle, the second unmanned powered vehicle connected to the second end of the sensor cable. Such a method according to the present invention may include one, or some, in any possible combination of the following: the at least one sensor cable is a plurality of sensor cables; remote control apparatus for communication with the unmanned powered vehicles for remotely controlling the first unmanned powered vehicle and the second unmanned powered vehicle; inflatable apparatus on the sensor cable for facilitating raising the sensor cable by inflating the inflatable apparatus; the sensor cable movable to a new location moving one or both unmanned powered vehicles; at least one of the unmanned powered vehicles including a data system for receiving and processing signals from the sensor cable and a communications system for transmitting data to a remote receiver, and/or a seismic source vessel having a seismic source thereon, the seismic source vessel movable with respect to the sensor cable, the seismic source activatable to produce signals transmitted to the strata beneath the seafloor, the sensor cable having sensors for receiving reflected signals from the strata, and a data system on at least one of the unmanned powered vehicles for receiving signals from the sensor cable.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventor may rely on the Doctrine of Equivalents to determine and assess the scope of the invention and of the claims that follow as they may pertain to apparatus or methods not materially departing from, but outside of, the literal scope of the invention as set forth in the following claims. All patents and applications identified herein are incorporated fully herein for all purposes. It is the express intention of the applicant not to invoke 35 U.S.C. § 112, by paragraph 6 for any limitations of any of the claims herein, except for those in which the claim expressly uses the words “means for” together with an associated function. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

1. A method for marine seismic surveying of strata beneath a seafloor beneath water, the method comprising
locating a seabed sensor cable with sensing apparatus on the seafloor, the seabed sensor cable having a first end connected to a first unmanned powered vehicle at a surface of the water and a second end connected to a second unmanned powered vehicle at the surface of the water, and
with the two unmanned powered vehicles, maintaining a location of the seabed sensor cable on the seafloor.

2. The method of claim 1 further comprising
remotely controlling the first unmanned powered vehicle and the second unmanned powered vehicle with a control function.

3. The method of claim 2 wherein the control function is on one of a mother vessel and a land site.

4. The method of claim 1 further comprising
raising the sensor cable by inflating inflatable apparatus on the cable.

5. The method of claim 4 wherein the inflatable apparatus is an air hose along a portion of the cable.

6. The method of claim 4 wherein the inflatable apparatus is an inflatable structure on a sensor pad, the sensor pad on the cable.

7. The method of claim 1 further comprising
raising the sensor cable by moving one or both unmanned powered vehicles.

8. The method of claim 1 further comprising
moving the sensor cable to a new location by moving one or both unmanned powered vehicles.

9. The method of claim 1 wherein at least one of the unmanned powered vehicles includes a data system for receiving and processing signals from the sensor cable and a communications system for transmitting data to a remote receiver, the method further comprising
receiving with the data system signals from the sensor cable,
processing the received signals with the data system, and
transmitting processed data from the data system to the remote receiver.

10. The method of claim 9 wherein the remote receiver is located on one of a mother vessel and a land site.

11. The method of claim 9 further comprising
transmitting the processed data from the at least one unmanned powered vehicle to the remote receiver via a satellite system.

12. The method of claim 1 further comprising
moving a seismic source vessel having a seismic source thereon with respect to the sensor cable,
activating seismic source production signals transmitted to the strata beneath the seafloor,
receiving reflected signals from the strata with the sensor cable, and
receiving signals from the sensor cable with a data system on at least one of the unmanned powered vehicles.

13. The method of claim 12 wherein the seismic source vessel moves transverse to the sensor cable.

14. The method of claim 12 wherein the seismic source vessel moves parallel to the sensor cable.

15. The method of claim 1 further comprising
re-locating the sensor cable on the seafloor using the two unmanned powered vehicles.

16. The method of claim 15 further comprising
using at least one of the unmanned powered vehicles, maintaining the sensing apparatus in coupling contact with the seafloor.

17. The method of claim 1 wherein the seafloor is two hundred feet or less below the surface of the water.

18. A method for marine seismic surveying of strata beneath a seafloor beneath water, the method comprising
locating a seabed sensor cable with sensing apparatus beneath water on the seafloor, the seabed sensor cable having a first end connected to a first unmanned powered vehicle at a surface of the water and a second end connected to a second unmanned powered vehicle at the surface of the water,
with the two unmanned powered vehicles, maintaining a location of the seabed sensor cable on the seafloor,
remotely controlling the first unmanned powered vehicle and the second unmanned powered vehicle with a control function,
wherein the control function is on one of a mother vessel and a land site,
raising the sensor cable by inflating inflatable apparatus on the seabed sensor cable,
wherein at least one of the unmanned powered vehicles includes a data system for receiving and processing signals from the seabed sensor cable and a communications system for transmitting data to a remote receiver, the method further comprising
moving a seismic source vessel having a seismic source thereon with respect to the seabed sensor cable,
activating the seismic source production signals transmitted to the strata below the seafloor,
receiving reflected signals from the seafloor with the seabed sensor cable,
receiving signals from the seabed sensor cable with the data system on at least one of the unmanned powered vehicles,
processing the received signals with the data system, and
wherein the remote receiver is located on one of a mother vessel and a land site.

19. A method for marine seismic surveying of strata beneath a seafloor beneath water, the method comprising
locating a plurality of seabed sensor cables each with sensing apparatus on the seafloor, the seabed sensor cables each having a first end connected to a first unmanned powered vehicle at a surface of the water and a second end connected to a second unmanned powered vehicle at the surface of the water, and
with the unmanned powered vehicles, maintaining locations of the seabed sensor cables on the seafloor.

20. The method of claim 19 wherein each of the sensor cables is of substantially the same length.

21. The method of claim 19 wherein at least two of the sensor cables are of different lengths.

22. The method of claim 19 wherein the sensor cables are parallel.

23. The method of claim 19 wherein at least two of the sensor cables are not parallel.

24. A system for marine seismic surveying, the system comprising
at least one seabed sensor cable with a first end and a second end,
a first unmanned powered vehicle, the first unmanned powered vehicle connected to the first end of the seabed sensor cable, and
a second unmanned powered vehicle, the second unmanned powered vehicle connected to the second end of the seabed sensor cable.

25. The system of claim 24 wherein the at least one sensor cable is a plurality of sensor cables.

26. The system of claim 24 further comprising
remote control apparatus for communication with the unmanned powered vehicles for remotely controlling the first unmanned powered vehicle and the second unmanned powered vehicle.

27. The system of claim 24 further comprising
inflatable apparatus on the sensor cable for facilitating raising the sensor cable by inflating the inflatable apparatus.

28. The system of claim 24 wherein the sensor cable is movable to a new location by moving one or both unmanned powered vehicles.

29. The system of claim 24 wherein at least one of the unmanned powered vehicles includes a data system for receiving and processing signals from the sensor cable and a communications system for transmitting data to a remote receiver.

30. The system of claim 24 further comprising
a seismic source vessel having a seismic source thereon, the seismic source vessel movable with respect to the sensor cable,
the seismic source activatable to produce signals transmitted to the strata beneath the seafloor,
the sensor cable having sensors for receiving reflected signals from the strata, and
a data system on at least one of the unmanned powered vehicles for receiving signals from the sensor cable.
